(19) United States
(12) Patent Application Publication
(10) Pub. No.: US 2017/0028909 A1
(43) Pub. Date: Feb. 2, 2017

(54) CARGO AND WORK LIGHT

(71) Applicant: Marcus Automotive, LLC, Holland, MI (US)

(72) Inventor: Jonathan P. Marcus, Holland, MI (US)

(21) Appl. No.: 15/217,044

(22) Filed: Jul. 22, 2016

Related U.S. Application Data
(60) Provisional application No. 62/199,326, filed on Jul. 31, 2015.

(51) Int. Cl. B60Q 3/06; B60Q 1/30; F21V 17/16; F21V 23/04; F21S 9/02

(52) U.S. Cl. CPC B60Q 3/06; F21V 23/0471; F21V 23/04; F21S 9/02; F21V 17/166; B60Q 1/30; B60Q 2500/00; F21Y 2115/10

(57) ABSTRACT

A window wiper motor housing is employed in a vehicle with a tailgate to mount a cargo light assembly which includes one or more sources of illumination. Upon raising the tailgate, a motion-actuated switch actuates the cargo and work light assembly to provide illumination downwardly toward the cargo area and/or rearwardly to facilitate use of the cargo area and/or the work area near the rear of the vehicle.

### CROSS-REFERENCE TO RELATED APPLICATIONS

This application claims priority under 35 U.S.C. §119(e) and the benefit of U.S. Provisional Application No. 62/199,326 entitled CARGO LIGHT, filed on Jul. 31, 2015, by Jonathan P. Marcus, the entire disclosure of which is incorporated herein by reference.

### BACKGROUND OF THE INVENTION

The present invention relates to an auxiliary light for illuminating the rear cargo area and behind the vehicle for a vehicle having a tailgate.

Many vehicles, including SUV style vehicles and Jeep® vehicles such as the JK, have tailgates that lift either as one section or two sections. The rear window typically includes a window wiper which is actuated by a motor mounted in a housing near the hinge area of the tailgate. When using the rear cargo area at night either for loading or unloading articles or other activities behind the vehicle, such as coupling a trailer hitch, lighting in the rear cargo area and behind the vehicle is minimal at best.

### SUMMARY OF THE INVENTION

This invention utilizes unoccupied space in the existing window wiper motor housing of a vehicle having a tailgate to mount a cargo light assembly. The cargo light assembly includes one or more lights which are illuminated upon raising the tailgate to provide illumination downwardly toward the cargo area and/or rearwardly to a work area to facilitate use of both the cargo area and the area near the rear of the vehicle. The rear-facing light also alerts oncoming traffic when the tailgate is raised when the vehicle is along the side of a road.

These and other features, objects and advantages of the present invention will become apparent upon reading the following description thereof together with reference to the accompanying drawings.

### BRIEF DESCRIPTION OF THE DRAWINGS

FIG. 1 is a fragmentary perspective view of a vehicle with a raised tailgate showing the mounting of a cargo light assembly of this invention;

FIG. 2 is an enlarged fragmentary perspective view of the cargo light assembly shown in FIG. 1;

FIG. 3 is a perspective view of the wiper motor housing and cargo light assembly shown removed from the vehicle;

FIG. 4 is a front elevational view of a wiper motor housing with a single light source;

FIG. 5 is a rear perspective view of a wiper motor housing showing the components of the cargo light assembly;

FIG. 6 is a rear perspective view of a wiper motor assembly showing components of an alternative embodiment of the cargo light assembly; and

FIG. 7 is an electrical circuit diagram in schematic form of the wiring of the cargo light assembly shown in FIGS. 1-6.

### DETAILED DESCRIPTION OF THE PREFERRED EMBODIMENT

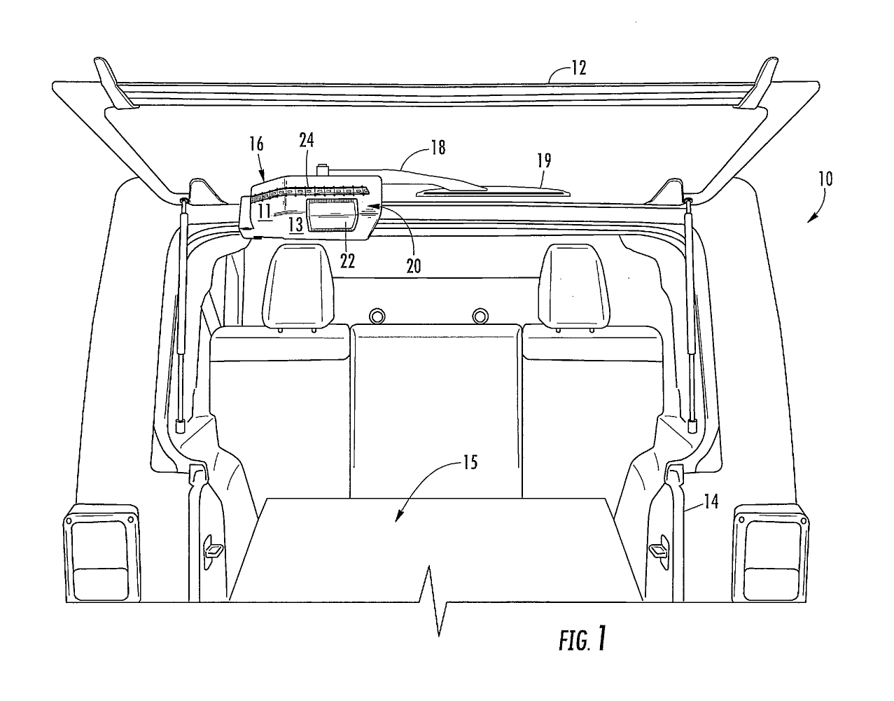

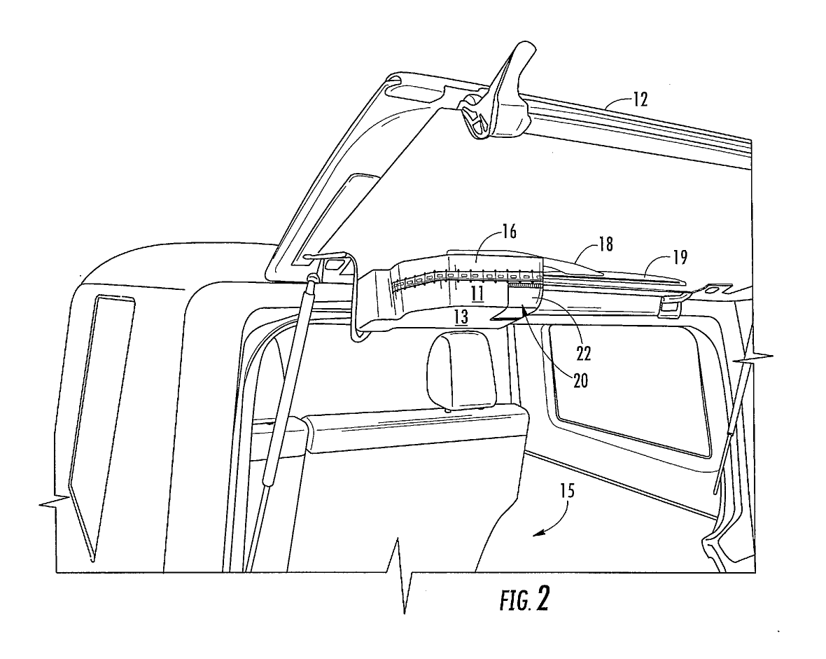

Referring initially to FIGS. 1 and 2, there is shown a vehicle 10, such as a Jeep® JK 10, having a two-piece tailgate including an upper window section 12 and a lower door section 14. Although shown in the environment of a Jeep®, this invention can be used with any type of vehicle having a one or two piece tailgate, which includes a window wiper and motor housing for the wiper motor. Mounted to the upper edge of window section 12 is a window wiper motor housing 16 for actuating an arm 18 holding a wiper blade 19. The shell-like housing 16 is typically molded of a thermoplastic material, such as PVC, and has considerable unoccupied space surrounding the wiper motor. Mounted within the available space in housing 16 is the cargo light assembly 20 of the present invention.

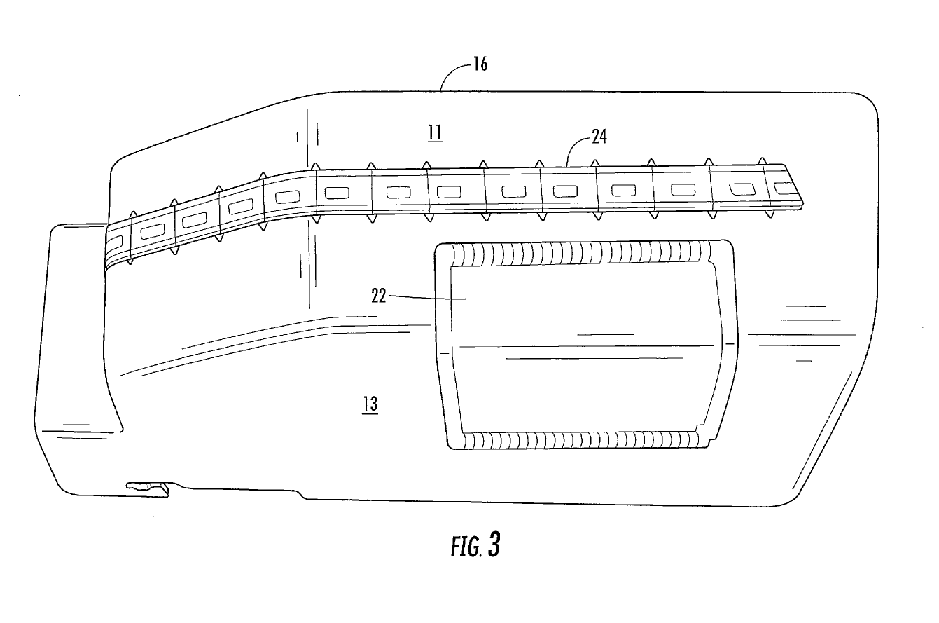

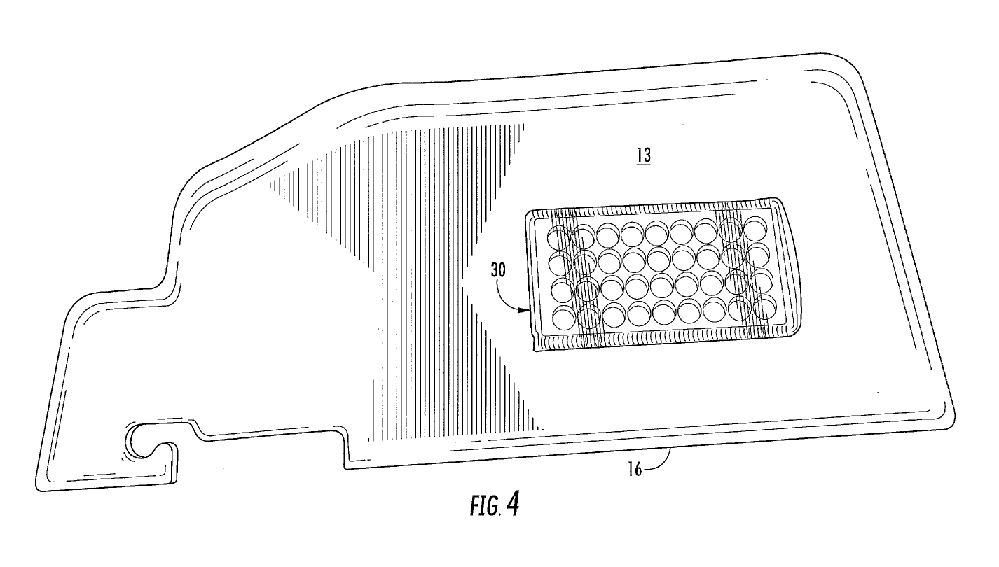

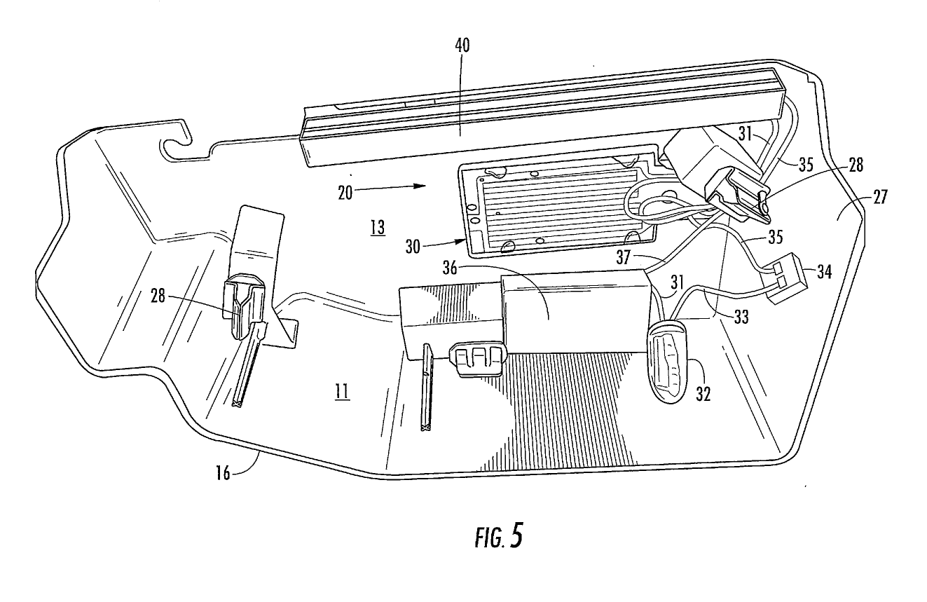

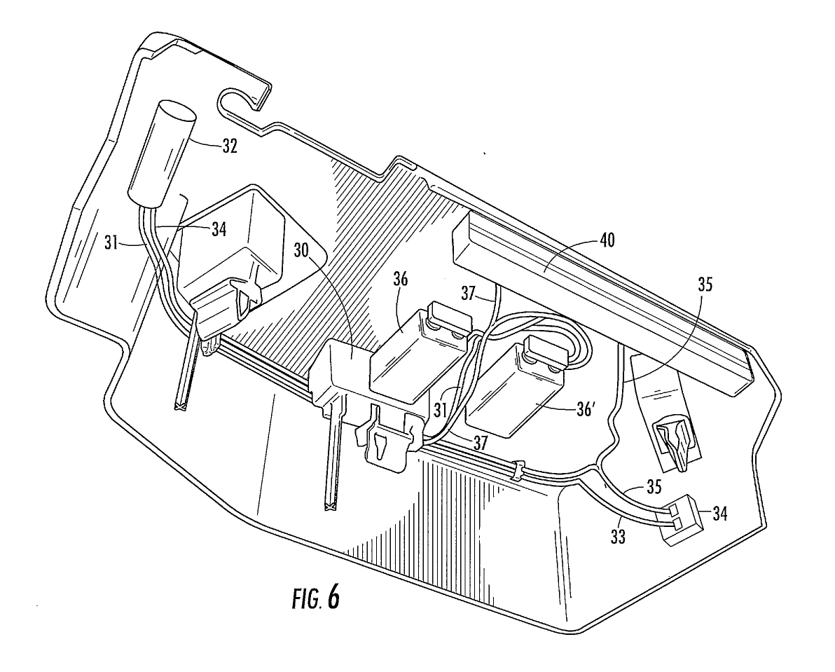

Cargo light assembly 20 includes one or more LEDs or other sources of illumination within the wiper motor housing 16, which basically is a hollow shell which covers the windshield wiper motor (not shown) driving the arm 18 for the wiper blade 19, as seen in FIGS. 1 and 2. The interior of the housing 16 is shown in the embodiments of FIGS. 5 and 6. In the first embodiment shown in FIGS. 1-3, mounted to apertures in the housing 16 is a first lens 22 behind which is a source of illumination, such as an LED, and a second strip light 24 which can be a series of LEDs which is mounted to housing 16 on a rear-facing wall 11 of the housing when the window section 12 of the tailgate is open, as seen in FIGS. 1 and 2. Lens 22 can extend on two planes of the housing 16, including the rearward facing wall 11 and a downward facing wall 13 to provide illumination both for the entire cargo area 15 of the vehicle and also behind the vehicle. By using the wiper motor housing as a mounting platform for the cargo light, unused space is efficiently employed for providing additional directed light not typically available from dome lights or tailgate lights in existing vehicles. The details of construction of the various embodiments are shown in FIGS. 4-7. It being understood that the same electrical components shown in these figures are employed in the first embodiment of FIGS. 1-3.

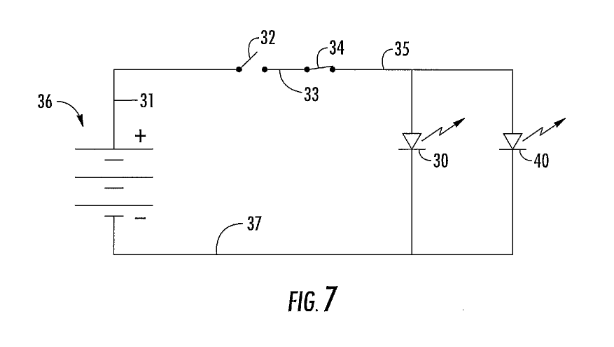

In FIGS. 4 and 5, a generally rectangular LED light array 30 is mounted to the wall 13 of housing 16 and faces outwardly from the housing 16. FIG. 5 shows details of the housing 16, which includes the outward facing wall 13 to which the LED array 30 is mounted, a curvilinear wall 11, and a side wall 17. The light assembly 20 shown in FIGS. 5 and 6 includes a motion-actuated switch 32 coupled in series with a manually actuated switch 34 (as seen in FIG. 7) coupling a power supply, such as a battery 36, to the LED array 30. Power is applied to the LED array 30 from battery 36 through motion-actuated switch 32 and manually actuated switch 34 when motion-actuator switch 32 detects that the tailgate window section 12 has been elevated. Switch 32 can be a mercury switch or other motion-controlled switch, allowing the motion of the tailgate to provide operating power to the LED assembly 30.

Switch 34 can be controlled by the operator to deactivate the lighting of the LEDs 30 when no light is desired but normally will be in a closed position, as shown in FIG. 7, to allow the motion of the window section 12 to provide illumination to the cargo area or wherever LEDs positioned on housing 16 are desired to provide illumination. Thus, in the first embodiment of FIGS. 1-3, LEDs are mounted to the wall 11 or the junction of walls 11 and 13 to direct illumination downwardly and rearwardly.

In FIG. 5, one conductor 31 from the battery is coupled to the motion actuator switch 32, which is coupled by a conductor 33 to manually actuated switch 34. Switch 34 has a conductor 35 extending to one or more LEDs, such as LED array 30 shown in FIG. 5, or the LEDs behind lenses 22 and 24 in the FIGS. 1-3 embodiment. The negative conductor 37 from battery 36 is coupled to the negative terminal of the light emitting diodes, as shown in the schematic diagram of FIG. 7.

The battery 36 and motion-actuator switch 32 are appropriately positioned within the housing 16 and held in place by conventional battery holding cartridges, clip mounts, or other suitable fasteners. Since the cargo light assembly is self-powered, preferably the battery 36 is mounted in a battery housing affixed to the interior of the housing 16 with mating contact clips, such that it can be easily replaced as necessary.

In FIG. 5, an LED light bar 40 is mounted to the edge of wall 13 to direct light inwardly and downwardly when the tailgate or window section 12 is raised. Light bar 40 is coupled in the circuit by conductor 37 from the battery and conductor 35 from switch 34, as shown also in FIG. 7. Light 30 directs illumination rearwardly behind the vehicle. When the circuit components, such as shown in FIGS. 4 and 5, are mounted to the housing, the housing can be snap-fitted using spring clips 28 which are part of the original housing assembly and which snap-fit the housing over receiving sockets adjacent the wiper motor. It is easily removed and reinstalled for replacement of the battery as necessary.

FIG. 6 shows an alternative embodiment of the mounting of the electrical components of the cargo light assembly 20 in which a pair of batteries 36 and 36′ are coupled in parallel to provide the operating power for the light bar 40 via motion-actuated switch 32 and a wire harness including conductors 31, 33, 35, and 37 as in the previous embodiment. Again, a second light 30 provides rearward illumination when the window section 12 is raised. Also, switch 34 in series with motion-actuated switch 32 can be manually changed to an open position to deactivate the cargo light as desired. The circuit for all of the embodiments is shown in FIG. 7.

It will become apparent to those skilled in the art that various modifications to the preferred embodiment of the invention as described herein can be made without departing from the spirit or scope of the invention as defined by the appended claims.

The invention claimed is:

1. A cargo and work light assembly for a vehicle having a tailgate that lifts upwardly and includes a wiper motor housing, said assembly comprising:
a wiper motor housing;
a source of electrical power;
a source of illumination; and
a motion-actuated switch coupled to said source of electrical power and to said source of illumination, said switch mounted to said wiper motor housing of a vehicle to provide operating power from said source of electrical power to said source of illumination when the tailgate is opened.

2. The cargo and work light assembly as defined in claim 1 wherein said source of illumination is at least one LED.

3. The cargo and work light assembly as defined in claim 1 wherein said source of illumination is a plurality of light sources positioned at different locations in said wiper motor housing.

4. The cargo and work light assembly as defined in claim 1 wherein said source of illumination includes a pair of LEDs mounted to the wiper housing and located to direct illumination in different directions.

5. The cargo and work light assembly as defined in claim 4 wherein said one of said LED's directs light rearwardly from the vehicle.

6. The cargo and work light assembly as defined in claim 5 wherein each of said LEDs comprise an array of individual LEDs.

7. The cargo and work light assembly as defined in claim 1 and further including a second manually actuated switch coupled in series with said motion-actuated switch to allow an operator to deactivate said cargo light assembly.

8. The cargo light assembly for a vehicle having a tailgate that lifts upwardly and includes a wiper motor housing, said assembly comprising:
a battery mounted to said wiper motor housing;
a first array of LEDs mounted to said wiper motor housing to direct illumination in a first direction;
a second array of LEDs mounted to said wiper motor housing to direct illumination in a second direction;
a motion-actuated switch coupled to said battery and to said first and second arrays of LEDS, said switch mounted to the tailgate of a vehicle to provide operating power from said battery to said arrays of LEDs when the tailgate is opened.

9. The cargo light assembly as defined in claim 8 wherein said first array of LEDs direct illumination toward the cargo area of the vehicle.

10. The cargo light assembly as defined in claim 9 wherein said second array of LEDs directs illumination rearwardly of the vehicle.

11. The cargo light assembly as define din claim 10 and further including a second manually actuated switch coupled in series with said motion-actuated switch to allow an operator to deactivate said cargo light assembly.

12. A vehicle having a tailgate that lifts upwardly and includes a wiper motor housing, said vehicle including:
a source of electrical power;
a source of illumination; and
a motion-actuated switch coupled to said source of electrical power and to said source of illumination, said switch mounted to said wiper motor housing to provide operating power from said source of electrical power to said source of illumination when the tailgate is opened.

13. The vehicle as defined in claim 12 wherein said source of illumination is at least one LED.

14. The vehicle as defined in claim 12 wherein said source of illumination is a plurality of light sources positioned at different locations in said wiper motor housing.

15. The vehicle as defined in claim 12 wherein said source of illumination includes a pair of LEDs mounted to the wiper housing and located to direct illumination in different directions.

16. The vehicle as defined in claim 15 wherein said one of said LED's directs light rearwardly from the vehicle.

17. The vehicle as defined in claim 16 wherein each of said LEDs comprise an array of individual LEDs.

18. The vehicle as defined in claim 12 and further including a second manually actuated switch coupled in series with said motion-actuated switch to allow an operator to deactivate said cargo light assembly.
